(19) United States
(12) Patent Application Publication
(10) Pub. No.: US 2018/0010748 A1
(43) Pub. Date: Jan. 11, 2018

(54) TRANSPORTABLE LIGHTING SYSTEM

(71) Applicant: APOLLO ENERGY SERVICES CORP., Airdrie (CA)

(72) Inventor: Matthew GOWANLOCK, Airdrie (CA)

(73) Assignee: APOLLO ENERGY SERVICES CORP., Airdrie, AB (CA)

(21) Appl. No.: 15/546,862

(22) PCT Filed: Dec. 17, 2015
(86) PCT No.: PCT/IB2015/059745

§ 371 Date: Jul. 27, 2017

Related U.S. Application Data
(60) Provisional application No. 62/109,966, filed on Jan. 30, 2015.

(51) Int. Cl. F21S 9/04; E04H 12/18; F21V 14/02; E04H 12/34; F21S 8/08; F21V 21/22; F21W 131/10; E21B 41/00

(52) U.S. Cl. CPC F21S 9/04; F21S 8/085; E04H 12/187; F21V 21/22; F21V 14/02; E04H 12/182; E04H 12/345; E21B 41/00; F21W 2131/1005

(57) ABSTRACT

A transportable lighting system. The lighting system is designed to withstand the difficult and extreme weather conditions typically experienced in outdoor work sites such as drilling rig environments. The pulley and roller arraignments are designed for minimal friction. The overall pulley and roller design for the lifting of the unit (including the way the cables are orientated) is extremely robust. The outrigger includes fold out and lock in place design. The power source can run a duel transfer switch setup powered by an external supply (like drilling rig power) or from its own 100% back-up generator. Lighting used is typically light in weight and bright. Towers are skid mounted and mobile, e.g., with the use of a truck. Individual lights can swivel and tilt as can the entire bank of lights.

### CROSS-REFERENCE TO RELATED APPLICATIONS

The instant application is an International Application claiming priority of U.S. Provisional Application No. 62/109,966, filed Jan. 30, 2015, the disclosure of which is hereby expressly incorporated by reference herein in its entirety.

### FIELD OF ART

The present invention relates generally to the field of lighting systems, and in particular to lighting systems for portable use.

### BACKGROUND

Drilling rigs are used to form wellbores for the purpose of extracting oil, natural gas or other fluids from subsurface deposits. Drilling rigs can also be used for sampling subsurface mineral deposits, testing rock or ground fluid properties and for installing subsurface utilities, instrumentations, tunnels or wells. In implementation, drilling rigs may be mobile equipment transportable by truck, rail, trailers, or similar, rigs may also be semi-permanent and permanent fixtures as in the case for oil drilling of large wells. Marine-based structures are also widely known. Generally, the term drilling rig refers to an arrangement of equipment that is used to penetrate the subsurface of the earth's crust.

Drilling operations, as well as work at other outdoor work sites, e.g., construction, mining, pipeline work, etc., typically occur during daylight hours and visibility in and around the drilling rig or work site has historically only been required when manual work is being done, inspection and calibration, for example. There is a desire to increase productivity by providing visibility during hours of low daylight, and this has thus far been accomplished by providing mobile lighting arrangements on vehicles proximate the drilling rig, or otherwise manually adding impromptu lighting arrangements.

However, because of the extreme weather conditions drilling operations typically occur in, for example high and low temperature conditions, and variable and high wind conditions, many lighting systems for this and other uses and environments have been found to be inadequate for these purposes.

### BRIEF SUMMARY

A transportable lighting system is described herein including a transportable, skid base, a stabilizing outrigger system attached to the base, at least one power generator attached to the skid base, a transfer switch connected to at least one power generator, an external power supply adapter connected to the transfer switch, an extendable tower system have a base end and a top end attached to the skid base, at least one set of lights attached to the top end, where the lighting system has a top load capacity of up to about 1500 pounds and is stable in wind gusts up to about 140 miles per hour (US Rating) and about 70 miles per hour constant wind speed (Canadian Rating).

Additional embodiments include: the lighting system described above, including two power generators connected by an additional transfer switch; the lighting system described above, including an additional transfer switch to connect at least one generator to an external power supply;

the lighting system described above, where the stabilizing outrigger system includes four, fold-out, lock-in-place, extendable legs; the lighting system described above including two power generators attached to the skid base; the lighting system described above, where the two power generators are connected to one another by a first transfer switch and connected to the external power supply adapter by a second transfer switch; the lighting system described above where the set of lights, and each light in the set, can swivel and/or tilt; the lighting system described above, where the tower system comprises at least two tower sections containing a hydraulic extension system contained within the tower sections; the lighting system described above, where the tower system includes at least three tower sections, containing a pulley extension system in at least one of the sections; the lighting system described above where the tower system includes four tower sections; the lighting system described above where the tower system is fully extended.

### BRIEF DESCRIPTION OF THE DRAWINGS

FIG. 1 is a side view of a lighting system described herein in the transport position.

FIG. 2 is a top view of a lighting system described herein with the tower hidden.

FIG. 3 is a side view of a lighting system described herein in the field position not showing the outriggers.

FIGS. 4 and 5 are perspective views of a lighting system described herein.

FIGS. 6a and 6b shows part of a telescopic tower system described herein.

FIG. 7 shows a tower section described herein containing a hydraulic ram sleeve.

FIG. 8 shows a perspective view of the top of a light bank described herein.

FIG. 9 shows a perspective view of the bottom of a light bank described herein.

FIGS. 10 and 11 shows schematic views of a cable and pulley system described herein.

FIG. 12 shows a schematic view of a tower bar locking system described herein.

### DETAILED DESCRIPTION

The particulars shown herein are by way of example and for purposes of illustrative discussion of the various embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description making apparent to those skilled in the art how the several forms of the invention may be embodied in practice.

The present invention will now be described by reference to more detailed embodiments. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are expressly incorporated by reference in their entirety.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Every numerical range given throughout this specification will include every narrower numerical range that falls within such broader numerical range, as if such narrower numerical ranges were all expressly written herein.

Additional advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed

As described above, the portable lighting systems described herein are specifically designed to withstand the difficult and extreme weather conditions typically experienced in harsh exterior conditions encountered especially in remote locations. For example, the lighting systems described herein can withstand sustained wind speeds up to about 70 miles per hour (MPH) and brief wind gusts (e.g., up to 3 seconds) of up to about 140 MPH. The systems are also designed and built to Canadian −45 (degree Celsius) structural cold weather steel ductility requirements, which represent extremely stringent standards.

The wheel and roller arrangements described herein are designed for minimal friction.

The power source for powering the lights and extending and contracting the telescopic lighting system towers typically contain dual power transfer switches. Power source can be external, such as that used to provide power to the drilling rig, for example, or the internal generator or back up generator contained in the lighting system itself. One switch provides the ability to switch between generators and an additional switch provides the ability to switch from the internal generators to an external power source. The switches can be manually or automatically operated, although automatic operation (e.g., triggered by failure of one of the power sources), would add additional cost to accommodate.

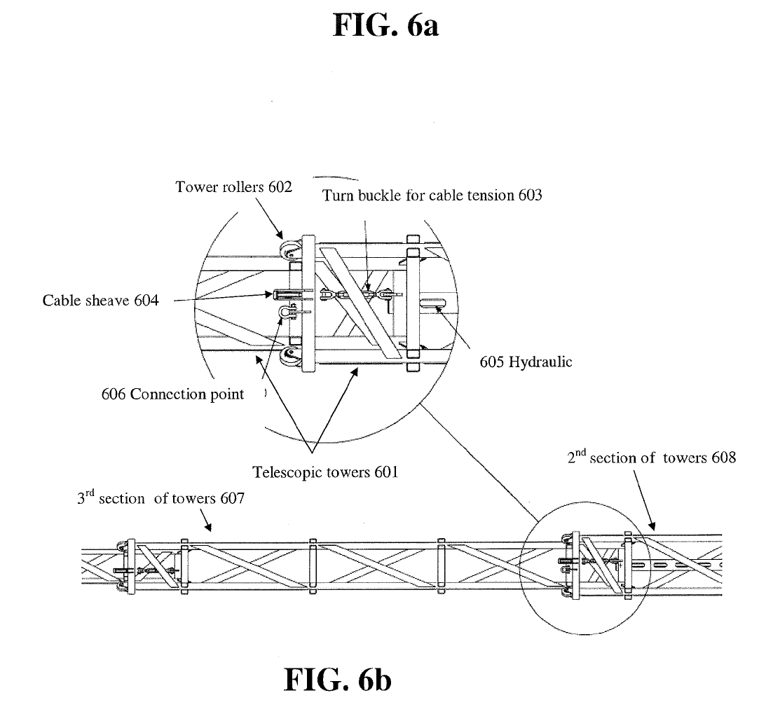

The overall pulley design for the lifting of the unit (for, example, the way the cables are orientated) is extremely robust. As demonstrated in FIG. 6, for example, the towers 601 are sized so as to fit one within another to allow for telescopic expansion when desired. The tower guide rollers 602 help to minimize friction within the system and provide added structural stability. Turn buckles 603 are also used to adjust the cable tension between the towers. The cable sheave 604, hydraulic bar 605 and cable attachment point 66 are also indicated.

The wheels and the rollers are set up as cams which can be fine-tuned and adjusted at full extension. For example, the units can be set up to have ¼ inch gap while rolling up and shim plates installed at the last 10″ of the tower extension. The cam rollers are set and wheels tightened to the shim plates (shim plates for example set up on the inside at the top of each section) so that the tower extends and retracts freely (¼ inch gap). At the last 10 inches of extension the tower comes tight in place due to the cams being set tight to the final shim plates.

Inner tower mast guide rollers 703 designed to contact the inner extendable tower mast when extended and contracted as the tower system moves in a vertical direction, typically present on the upper portion of the tower mast 701, cable sheave 702, hydraulic ram sleeve 704, and outer tower mast guide rollers 703, typically present on the lower portion of the tower mast and designed to contact the inner portion of the larger telescoping tower mast below it when extended and contracted as the tower system moves in a vertical direction are also shown.

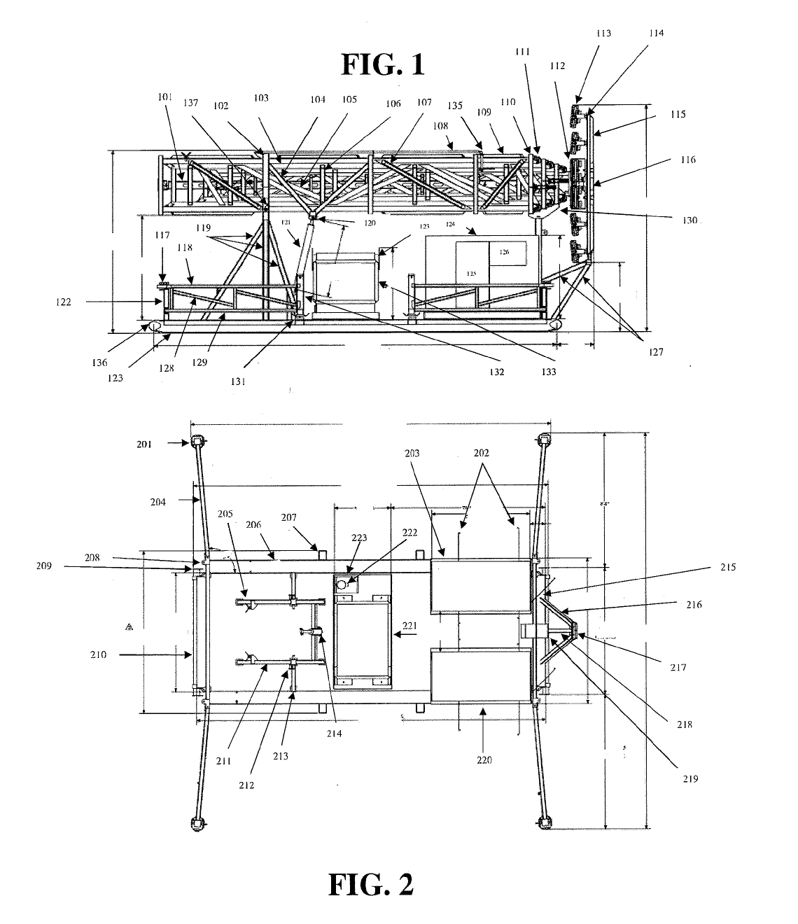

The outrigger design (fold out and lock in place), while relative simple, is easy to use and works extremely well—quick, safe and efficient in set up. As demonstrated in FIGS. 1 and 2, it can basically be made up of a jack 132 containing an adjustable base 131 which sits on the ground when extended, connected to a post 122 securely attached to skid base 123 through a system of parallel vertical, horizontal and angles bars 128, 129 and 122. The bars lock in place when extended as shown in FIG. 2, to provide extreme stability (as described herein), to the extended tower structure.

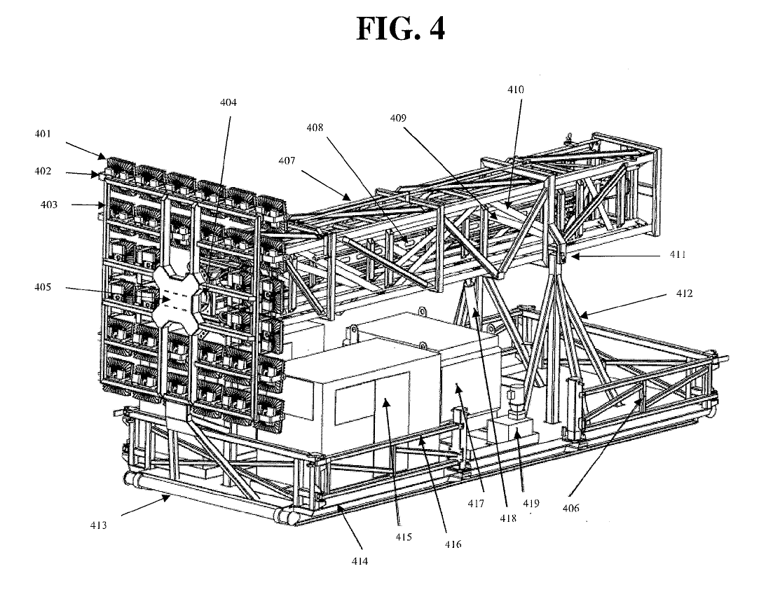

The overall layout, including the wide footprint, of the system described herein is extremely stable, and can accomplish the described wind resistance without the need for added guide wires, anchors, or other external stability aids. The system described herein also includes commercially available duel transfer switch setup to allow the lighting system to be powered by an external power supply (for example, like power supply powering the rig power) or from its own generator and (100% power) back-up generator. So the first transfer switch will allow switching from internal generator #1 to generator #2 and the second transfer switch will allow switching from generator 1 or 2 to an external power source. Transfer switches can be located at any convenient location where space is available on the skid, for example, on a support panel placed between 412 and 406 shown in FIG. 4.

While any lights can be used, the lighter and brighter the lights the better. For example, individual lights which are actively cooled (e.g., fan to cooled) would allow the housing to be lighter as compared to conventional LED fixtures, which typically use larger surface areas to cool (larger areas are also heavier and adds more sail area for wind loading calculations). While many different styles of light may be used, output vs weight/surface area is a consideration. The use of aluminum in the light frames, etc. is also a consideration in this regard.

As mentioned, the transportable lighting system described herein is skid mounted and completely mobile, while providing extreme temperature and weather tolerance and wind stability. It is relatively easy to move with the use of conventional trucks and extremely easy to set up for use and operate.

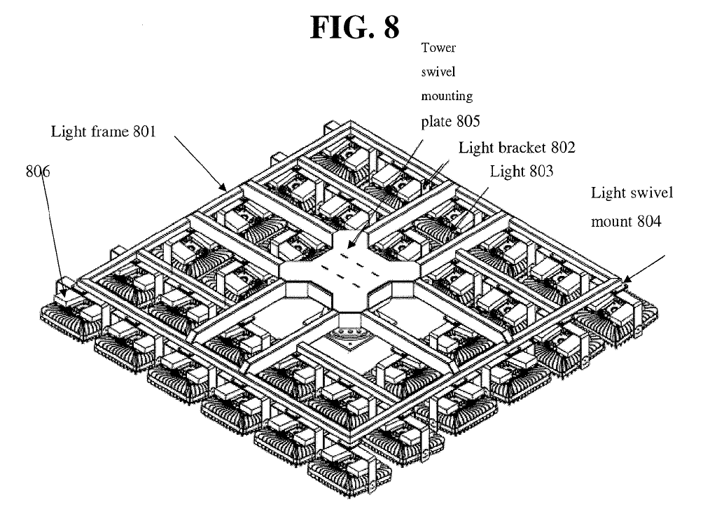

The entire light bank is also designed so that it can swivel and tilt, as can each individual light in the bank of lights. The position of each individual light as well as the light bank itself can be pre-set manually, or designed with motor controls to allow adjustments remotely. FIG. 8 shows a bank of lights useful herein, including to top section of the light bank swivel mounting plate 805, the individual lights 803, a light bracket 802 which provides for light movement for the face of the light in an up and down plane in a vertical direction, and a light swivel mount 804 which provides for light movement for the face of the light in a horizontal plane right and left.

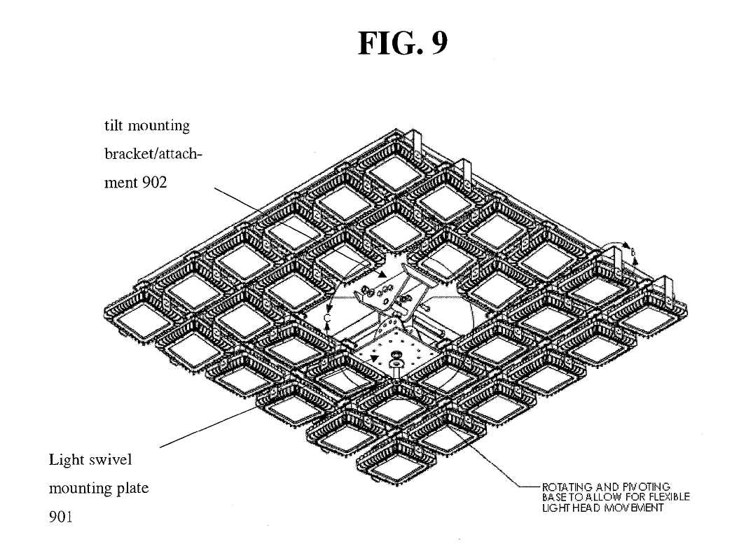

Similarly, as shown in FIG. 9, the entire light bank is attached to the tower with hardware which allows for the entire bank of lights to move in vertical and horizontal planes as described above for the individual lights. A representative light bank swivel mounting plate, for example, is shown as 901 and a representative light bank tilt mounting bracket/attachment, for example, is shown as 902.

As can be appreciated, while the towers described herein are particularly useful extended to heights of about 75 feet, they can be used at heights below 75 feet, and designed for use at extended heights greater than 75 feet as well. The tower can also be raised in shorter segments to accommodate different height usage desires, for example, in five foot increments until the desired use height is attained.

In a representative system as shown in FIG. 1, 101 is a conventional, commercially available (e.g., 16 foot long) hydraulic ram which runs up through the middle of the entire tower in the collapsed or transport position. It goes from the bottom of the first tower section all the way to the top of the second section. It pushes the second section up as the tower is extending. All of the tower sections are designed to extend at the same time using the integrated pulley system described herein. See FIGS. 6, 7, 10 and 11.

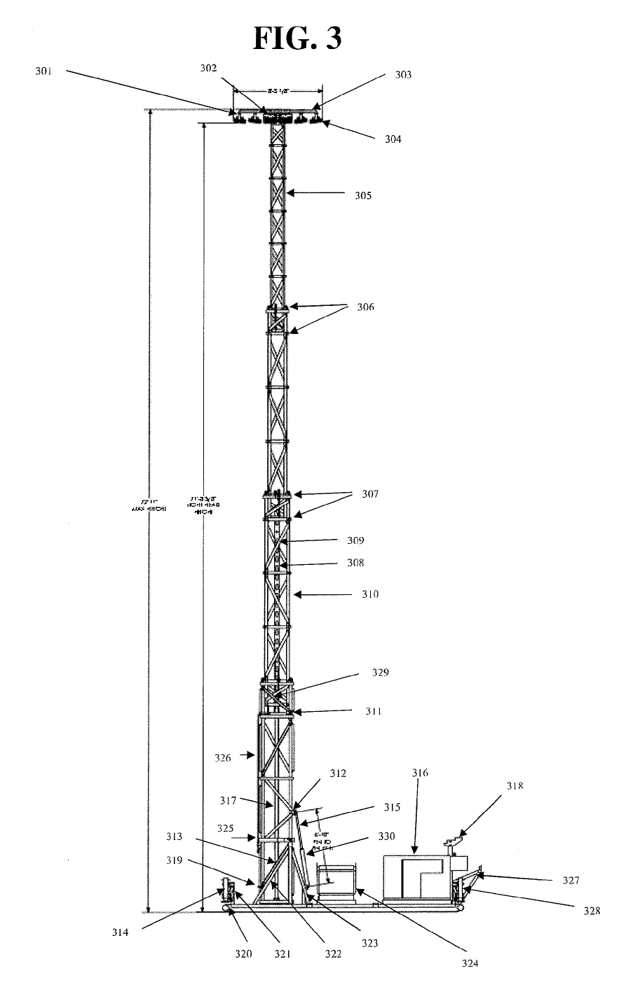

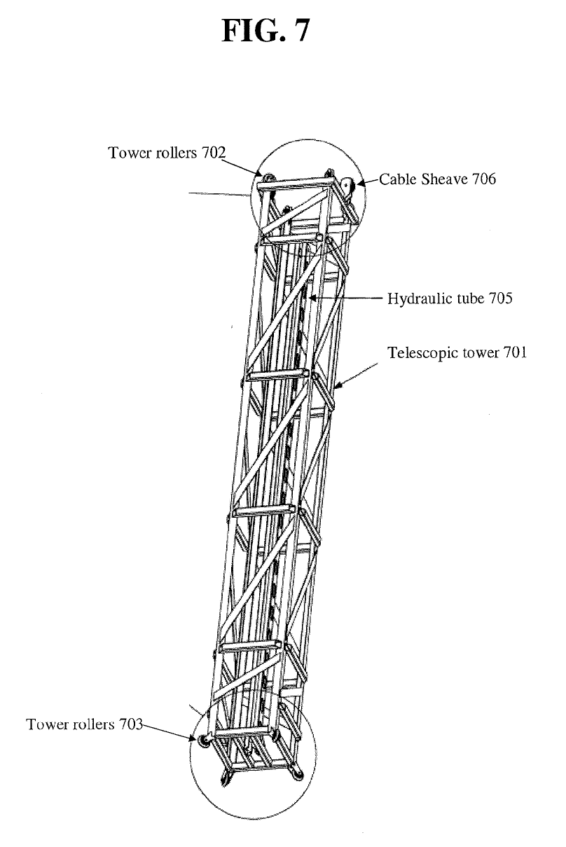

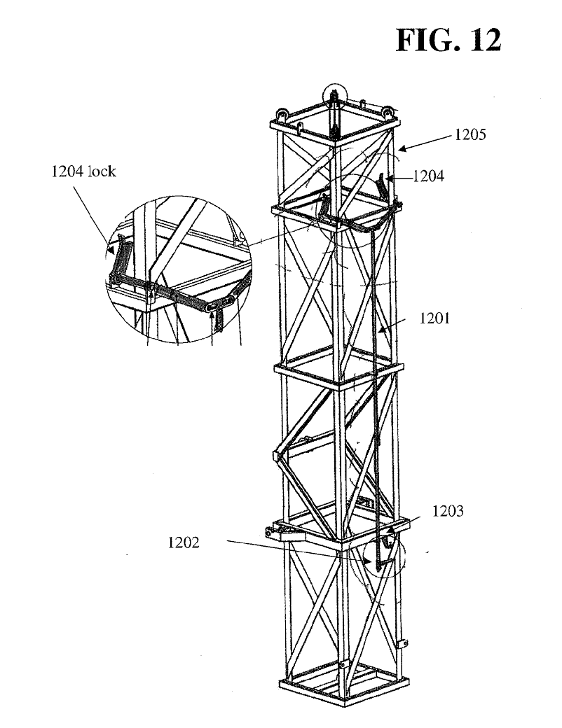

The exemplary standalone 75 foot tower depicted in FIG. 1 has four sections which telescope out, and up, as the hydraulic ram is extended. The bar 102 wraps around the lower tower section on all four sides, helping to provide stability to the tower in both the collapsed and extended position., and pivots at the point of the pivot pin (137) on both front (shown) and it's back, mirror image side (not shown). The main members of the inner tower sections are shown, e.g. at 103. The main members of the tower sections are typically made of steel HSS (Hollow Structural Solutions) tubing and angle iron. 104 is an HSS cross piece attached and affixed to the outermost tower section to allow the hydraulic ram 121 to tilt and raise the tower sections. 105, 106 and 107 are representative cross section affixed to and part of the tower sections. 108 is a locking mechanism (L shaped as shown at 135; see also 325 in FIG. 3) which locks bottom section in place and holds bottom section of the 2^{nd} mast in place when extended. See 326 in FIG. 3, and FIG. 12. When extended, the additional tower sections are held in place by the cables that are attached. The locking system described herein helps to take the weight off of the ram, with the cables holding the extended towers as described. 109 is a representative side piece of the mast. 110 is the top of first section. 111 are the tower roller wheel shown in greater detail in FIGS. 6 and 7. All of the roller wheels and cable sheaves are steel. The cables extend through the middle of the masts. 130 is a resting structure for the masts during transport. A representative steel skid is shown as 123.

The lights 113 shown here are similar to the lights shown in commonly assigned, co-pending U.S. patent application Ser. No. 14/093,097, the disclosure of which is herein incorporated by reference. The lights as well as the entire light bank can both tilt and swivel to better focus the lights on the intended illumination target. The lights connected by light support 114 to the frame 115 are typically aluminum for weight reasons, although other materials can be used. 116 is the cover for the light frame tilt and swivel mechanism, which is between the frame and the tower.

117 is pivot point for the outrigger vertical support piece 122 and is where the locking pin for the outrigger bar structure 118 is located. 119 are the structural bars attached to the skid to support the tower sections during transport and the pivot point for vertical orientation and extension. 121 is the hydraulic ram used for tilting the tower sections into a vertical orientation from connection point 120. 133 is a double walled fuel tank containing the fuel to power the two attached power generators (124 and 203 in FIG. 2). Diesel fuel is the fuel preferred. The tank is typically designed to meet all fuel tank transportation approvals to allow for transporting the unit with fuel in the tank. One such tank is offered by Petro Industries. 124 is one of two generators typically arranged side by side which can also be seen in FIG. 2. 30 kilowatt John Deere generators are particularly useful. Representative breaker and control panel locations can be at 125 and 126 respectively. 127 is a light head support attached to the skid especially provided to add stability during transport. 132 indicates one of the four conventional, commercially available jacks provided in the outrigger system, which swings out, and is crank adjusted to accommodate the ground level adjustments needed for skid and tower stability. 136 is part of skid, one of four “ear” pieces attached to the skid to allow cable or other connection for loading and unloading, for example, with a winch tractor. The skid is typically made of steel also.

In FIG. 2, a top view of a segment of the system at ground level (tower sections not shown) the adjustable jacks 201 jacks are shown, providing stability on even and uneven surfaces, attached to the stabilizing bars 204 of the outrigger system. The doors 202 to the generators are shown in an open position. The (diesel) fuel tank 221 supplies power generators 203 and 220. The Y shaped locking bolts 205 are placed in a locking position when the lower tower section (not shown) is tilted into a vertical position. 212 is the hinge point connecting the lower tower section to the skid. 213 are stabilizing bars for stabilizing the lower tower section to the skid. 214 is the tilting hydraulic use for tilting the tower sections from a horizontal to a vertical position, and vice versa. 206 are the skids, and 207 pads connected to the skids where the outrigger rests during transport. 208 is the locking pin to lock the arms of the outrigger when fully extended for system stability in use. 210 is the front roll bar, part of the skid, to assist in loading and unloading the skid during transport, with “ear” 209 for attaching cable when used to assist in loading and unloading. 211 is a stationary support bar for tilting and anchoring the tower sections. 223 is the hydraulic fluid holding tank, and 222 the fluid pumping motor. 215 is back end roll bar. 216 is the light support, and 217 the light head cradle. 219 is an additional structural support to the light supports.

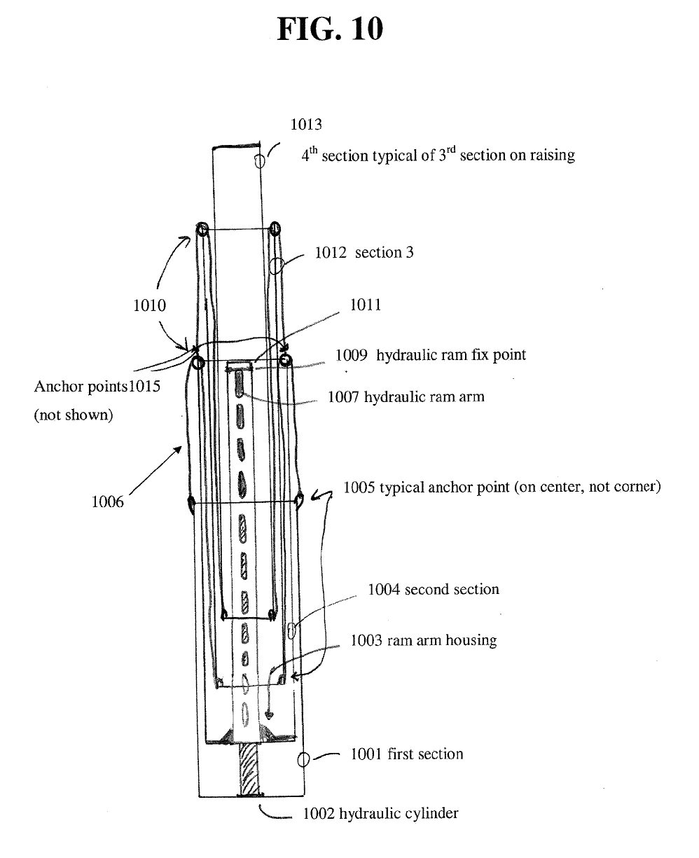

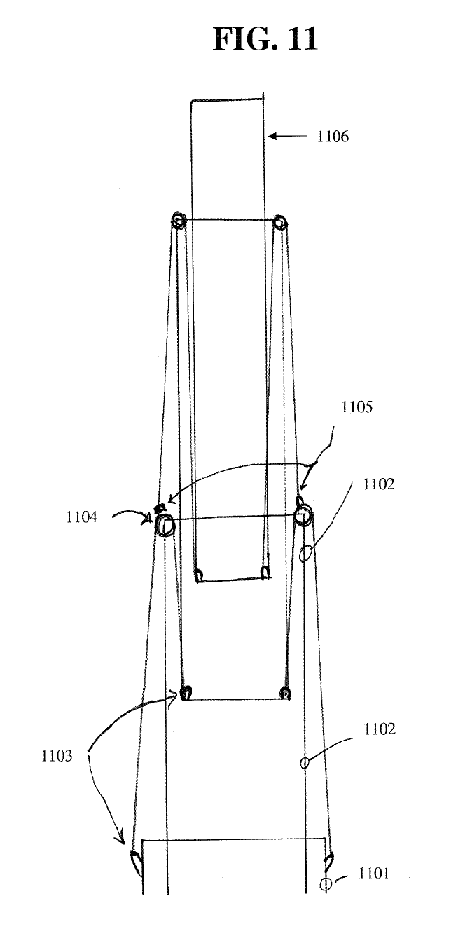

The lighting system is shown fully extended in FIG. 3. The lights 304 are connected by light brackets 301 to the light frame 303. The light frame is connected to the tower section 305 through a tower swivel mounting plate 302. The cable system extends inside all of the masts or tower sections. As the hydraulic ram pushes the second tower section out of the first tower section, the pulley system is in place to cause all of the towers to begin to extend simultaneously. See FIGS. 10 and 11 for a schematic of how a pulley and cable system as described herein can be arranged and works. Cables on distributed on both sides of the tower sections to provide for an even pull and extension. The second tower section gets pushed up out of the first tower section, by the hydraulic cylinder 308. The cylinder has an enclosure and lift structure which helps to keep it centered in the tower. 309 is a structural cross bar. The second tower section 310 is pushed up by virtue of the hydraulic cylinder. The lower tower section just gets tilted up and otherwise remains in place, securely attached to the pivoting cross bar section (shown here in its horizontal orientation). The cable from attached to the bottom of the 3^{rd} tower section goes up to the top of the second section and is then routed back down attached to first section. The cable attached to the top of the 4^{th} is also routed through cable pulleys at the top of section 3 and attached to the second section anchor point, to cause all of the tower sections to expand simultaneously. 306 and 307 are the guide wheels (also shown in FIGS. 6 and 7) at top and bottom of each section which help the tower sections to extend and contract in an even, stable manner Locking bar 329, is a manual bar which is just pulled down to provide added stability to the first section. It is generally pulled up and lowered down to take the weight off the hydraulics and pivots at point 311. 317 is the hydraulic ram cylinder. The hydraulic ram arm (rod) slides in and out of 308 (cylinder enclosure and lift structure). The ram is connected to the top of 308 and pushes it up as it extends and 308 is connected only at the bottom to the second tower section.

315 is the hydraulic rod or arm used for tilting the tower structure from horizontal to vertical, and vice versa, extending out of hydraulic ram 330. 312 is where it connects to the tower. 322 and 323 are the structural cross members (also shown in FIG. 1 which connect the tower section to the skid. 319 at the end of 313 is the locking bolt Y also shown in FIG. 1. 320 is the roller on the skid. 314 and 328 are side views of the jack portions of the outrigger and 321 part of the structural frame where the outriggers connect to the jack. 318 is a tower support where the towers rest during transport and 327 where the light head rests. 324 is the (diesel) fuel tank for the generator, such as generator 316 shown.

FIG. 4 shows a perspective view of the lighting system described herein in the transport orientation, and demonstrates lights 401, light brackets 402, light frame 403, light bank tilt and swivel piece 404, tower swivel mounting plate 405, outrigger stability bar structures 406 and 416, telescoping tower sections 407, hydraulic ram for extending the second section 408, structural cross supports 409 and 410, tower transport structural support 412 with tower pivot point 411, skid roll bar 413 on skid 414, one of the power generators 415, power generator fuel tank 417, hydraulic apparatus for tilting the tower structure from horizontal to vertical, and vice versa, 418, and hydraulic fluid tank 419.

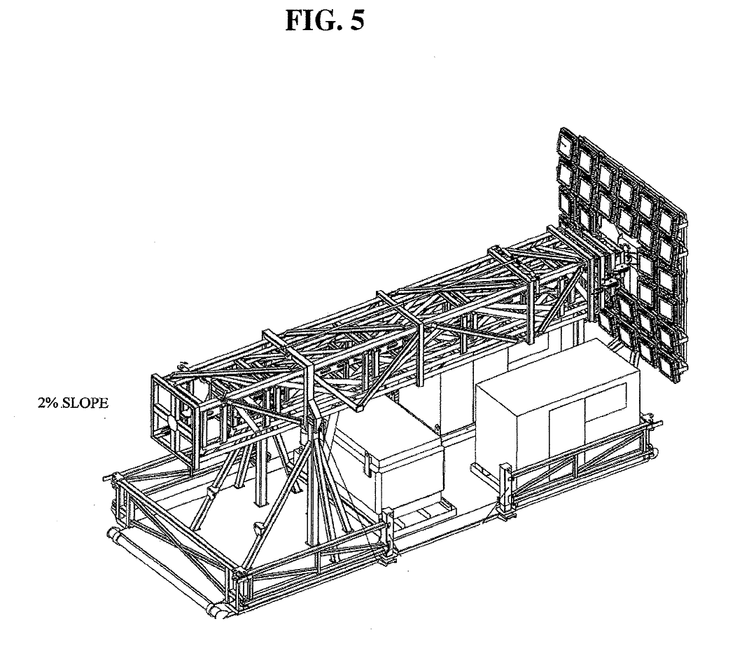

FIG. 5 shows a perspective view of the lighting system described herein in the transport orientation from an angle opposite that of FIG. 4.

FIG. 6a (blow-up of a section of FIG. 6b) shows connection points of a second tower section to a third tower section including the telescopic tower sections 601, external tower rollers 602, cable tension turn buckle 603, cable sheave 604, tower extending and contracting hydraulic ram 605, and cable connection point 606, inside the cylinder enclosure and lift structure.

FIG. 7 shows a tower segment section 701 including internal 702 and external 703 tower roller guides, hydraulic cylinder enclosure and lift structure 705 containing the hydraulic ram, and cable sheave 706.

FIG. 8 shows a top view of a light bank as described herein, including a light frame 801, a light bracket 802 which provides for the tilting of individual lights 803, light swivel mounts 804 which provides for the rotation of individual lights, and a tower swivel mounting plate 805. Also shown is DC power supply 806 which converts the AC into DC voltage.

FIG. 9 shows a bottom view of the light bank shown in FIG. 8 including a light swivel mounting plate 901, which allows for rotation of the light frame and entire bank of lights, and a tilt mounting attachment 902 which allows for light frame tilt adjustments for the entire bank of lights.

As shown in FIGS. 10 and 11, the tower sections are all interconnected by the cable system described herein. The cables are firmly in place in both the tower collapsed and tower extended positions by virtue of the cable anchor points (e.g., 1015). Because the towers extend in a coordinated fashion, by virtue of the movement as the ram pushes the ram housing lifting the second section from the bottom, the tower sections extend by virtue of the movement of the towers through the cables and the rollers. FIG. 10 demonstrates the following elements of the system: the hydraulic cylinder 1002, the first tower section 1001, the ram arm housing 1003 which pushes up this housing to lift the second section from the bottom, the second section 1004, the anchor points 1005 typically on the center of the tower side and not on the corner, the cable 1006, the hydraulic ram arm 1007, the hydraulic ram fixed point 1009, the cable rollers 1010 (it should be noted that the hydraulic ram arm as demonstrated is not connected to the tower section at the top 1011 but only at the bottom of the second tower section), the third section 1012, and the fourth section 1013.

In FIG. 11, the following elements are also demonstrated: the first tower section 1101, the second tower section 1102, which is pushed by the hydraulic ram arm (not shown), the cable anchor points 1103, the cable rollers 1104, the anchor points 1105 beside the rollers for the fourth section, and the fourth section 1106. As the second section is forced up by the hydraulic ram, it automatically pulls up sections three and four. As the hydraulic ram retracts, the cables still hold tension and always remain in place.

A locking system for the towers as described herein is demonstrated in more detail in FIG. 12, including the first section 1205 containing the locking system, the handle 1202 which is raised or lowered out of its resting cradle 1203, which simultaneously raises and lowers the locks 1204 through the connecting rod 1201. The lock can be set at any incremental extension of the towers as described above as well.

The scope of the claims should not be limited by the preferred embodiments set forth in description of the preferred embodiments or in the examples, but should be given the broadest interpretation consistent with the description as a whole.

1. A transportable lighting system comprising:
a. a transportable, skid base,
b. a stabilizing outrigger system attached to the base,
c. at least one power generator attached to the skid base,
d. a transfer switch connected to at least one power generator,
e. an external power supply adapter connected to the transfer switch,
f. an extendable tower system have a base end and a top end attached to the skid base,
g. at least one set of lights attached to the top end,
wherein the lighting system has a top load capacity of up to about 1500 pounds and is stable in wind gusts up to 140 miles per hour and about 70 miles per hour constant wind speed.

2. The lighting system according to claim 1, including two power generators connected by an additional transfer switch.

3. The lighting system according to claim 2, including an additional transfer switch to connect at least one generator to an external power supply.

4. The lighting system according to claim 1, wherein the stabilizing outrigger system comprises four, fold-out, lock-in-place, extendable legs.

5. The lighting system according to claim 1, including two power generators attached to the skid base.

6. The lighting system according to claim 5, wherein the two power generators are connected to one another by a first transfer switch and connected to the external power supply adapter by a second transfer switch.

7. The lighting system according to claim 1, wherein the set of lights, and each light in the set, can swivel and/or tilt.

8. The lighting system according to claim 1, wherein the tower system comprises at least two tower sections containing a hydraulic extension system contained within the tower sections.

9. The lighting system according to claim 1, wherein the tower system comprises at least three tower sections, containing a pulley extension system in at least one of the sections.

10. The lighting system according to claim 9, wherein the tower system comprises four tower sections.

11. The lighting system according to claim 1, wherein the tower system is fully extended.
